(19) United States
(12) Patent Application Publication
(10) Pub. No.: US 2022/0130260 A1
(43) Pub. Date: Apr. 28, 2022

(54) MOBILITY SERVICE SYSTEM AND MOBILITY SERVICE DELIVERY METHOD

(71) Applicant: TOYOTA JIDOSHA KABUSHIKI KAISHA, Toyota-shi Aichi-ken (JP)

(72) Inventors: Shun Ota, Susono-shi Shizuoka-ken (JP); Yoshifumi Otaki, Nagoya-shi Aichi-ken (JP)

(21) Appl. No.: 17/510,939

(22) Filed: Oct. 26, 2021

(30) Foreign Application Priority Data
Oct. 28, 2020 (JP) 2020-180776

(51) Int. Cl. G08G 5/00; B64C 29/00

(52) U.S. Cl. CPC G08G 5/006; G08G 5/003; B64C 2201/108; B64C 29/00; G08G 5/0013

(57) ABSTRACT

A mobility service system delivers a mobility service utilizing an eVTOL. A flight database includes flight record information indicating a correspondence relationship between a combination of a point of departure and a destination, a flight route, and an energy efficiency, regarding each past flight utilizing the eVTOL. An intrusion avoidance zone is a zone into which the eVTOL is recommended to refrain from intruding. The mobility service system determines a target flight route of a first flight of a first eVTOL from a first point of departure to a first destination. Specifically, based on the flight database and the intrusion avoidance zone, the mobility service system determines one with a highest energy efficiency among past flight routes that are from the first point of departure to the first destination and do not intrude into the intrusion avoidance zone, as the target flight route of the first flight.

### CROSS-REFERENCE TO RELATED APPLICATIONS

This application claims priority to Japanese Patent Application No. 2020-180776 field on Oct. 28, 2020, the entire contents of which are herein incorporated by reference.

### BACKGROUND

### Technical Field

The present disclosure relates to a technique of delivering a mobility service utilizing an electric vertical takeoff and landing aircraft (eVTOL).

### Background Art

Japanese Laid-Open Patent Application Publication No. JP-2019-214370 discloses an electric multi-rotor aircraft. For example, the electric multi-rotor aircraft is an electric vertical takeoff and landing aircraft.

### SUMMARY

In recent years, a concept of MaaS (Mobility as a Service) has been proposed, and a mobility service utilizing a variety of mobility modes (transportation) in an integrated manner has been proposed. It is conceivable to utilize, as the mobility modes, not only a ground mobility modes such as an automobile and a train but also an air mobility modes. In particular, it is conceivable to utilize an eVTOL as the air mobility modes.

An object of the present disclosure is to provide a technique capable of determining an appropriate flight route of the eVTOL in the mobility service utilizing the eVTOL.

A first aspect is directed to a mobility service system that delivers a mobility service utilizing an electric vertical takeoff and landing aircraft (eVTOL).

The mobility service system includes one or more processors and one or more memories.

The one or more memories are configured to store:
a flight database including flight record information at least indicating a correspondence relationship between a combination of a point of departure and a destination, a flight route, and an energy efficiency, regarding each past flight utilizing the eVTOL; and
intrusion avoidance zone information indicating an intrusion avoidance zone into which the eVTOL is recommended to refrain from intruding.

The one or more processors are configured to execute a flight route determination process that determines a target flight route of a first flight of a first eVTOL from a first point of departure to a first destination.

In the flight route determination process, based on the flight database and the intrusion avoidance zone information, the one or more processors determine one with a highest energy efficiency among past flight routes that are from the first point of departure to the first destination and do not intrude into the intrusion avoidance zone, as the target flight route of the first flight.

A second aspect is directed to a mobility service delivery method that delivers a mobility service utilizing an electric vertical takeoff and landing aircraft (eVTOL).

The mobility service delivery method is performed by a computer executing a computer program.

The mobility service delivery method includes a flight route determination process that determines a target flight route of a first flight of a first eVTOL from a first point of departure to a first destination.

The flight route determination process includes:
accessing a flight database including flight record information at least indicating a correspondence relationship between a combination of a point of departure and a destination, a flight route, and an energy efficiency, regarding each past flight utilizing the eVTOL;
accessing intrusion avoidance zone information indicating an intrusion avoidance zone into which the eVTOL is recommended to refrain from intruding; and
determining, based on the flight database and the intrusion avoidance zone information, one with a highest energy efficiency among past flight routes that are from the first point of departure to the first destination and do not intrude into the intrusion avoidance zone, as the target flight route of the first flight.

According to the present disclosure, the flight database regarding the past flights utilizing the eVTOL is prepared. The flight database at least indicates a correspondence relationship between a combination of the point of departure and the destination, the flight route, and the energy efficiency, for each past flight. In addition, the intrusion avoidance zone information indicates the intrusion avoidance zone into which the eVTOL is recommended to refrain from intruding. The flight database and the intrusion avoidance zone information are used for determining the target flight route with respect to a certain combination of the point of departure and the destination. More specifically, one with the highest energy efficiency among the past flight routes not intruding into the intrusion avoidance zone is determined as the target flight route. In this manner, it is possible to determine an appropriate flight route in terms of an energy efficiency and the intrusion avoidance zone.

### BRIEF DESCRIPTION OF DRAWINGS

FIG. 1 is a conceptual diagram for explaining an outline of a mobility service;

FIG. 2 shows a variety of examples of combinations of mobility modes utilizing an eVTOL;

FIG. 3 is a schematic diagram showing a configuration of a mobility service system;

FIG. 4 is a block diagram showing a configuration example of an eVTOL;

FIG. 5 is a block diagram showing a configuration example of a pilot terminal;

FIG. 6 is a block diagram showing a configuration example of a takeoff and landing site;

FIG. 7 is a block diagram showing a configuration example of a local terminal;

FIG. 8 is a block diagram showing a configuration example of a user terminal;

FIG. 9 is a block diagram showing a configuration example of a management server;

FIG. 10 is a block diagram showing an example of user information;

FIG. 11 is a block diagram showing an example of eVTOL service management information;

FIG. 12 is a conceptual diagram showing an example of takeoff and landing site information;

FIG. 13 is a flow chart showing a reservation process performed by a management server;

FIG. 14 is a flow chart showing a first example of an itinerary planning process (Step S200);

FIG. 15 is a flow chart showing an example of Step S220;

FIG. 16 is a flow chart showing a second example of the itinerary planning process (Step S200);

FIG. 17 is a flow chart showing a third example of the itinerary planning process (Step S200);

FIG. 18 is a conceptual diagram showing an example of information displayed on a display device in an itinerary presentation process (Step S300);

FIG. 19 is a conceptual diagram showing another example of information displayed on the display device in the itinerary presentation process (Step S300);

FIG. 20 conceptually illustrates a flight utilizing the eVTOL;

FIG. 21 is a conceptual diagram illustrating an example of intrusion avoidance zones and flight routes;

FIG. 22 is a conceptual diagram showing an example of a flight database;

FIG. 23 is a conceptual diagram showing another example of a flight database;

FIG. 24 is a conceptual diagram showing still another example of a flight database;

FIG. 25 is a block diagram showing a configuration example of the eVTOL;

FIG. 26 is a block diagram showing a configuration example of the management server; and

FIG. 27 is a flow chart showing a flight route determination process.

### DETAILED DESCRIPTION

Embodiments of the present disclosure will be described with reference to the accompanying drawings.

### 1. Mobility Service

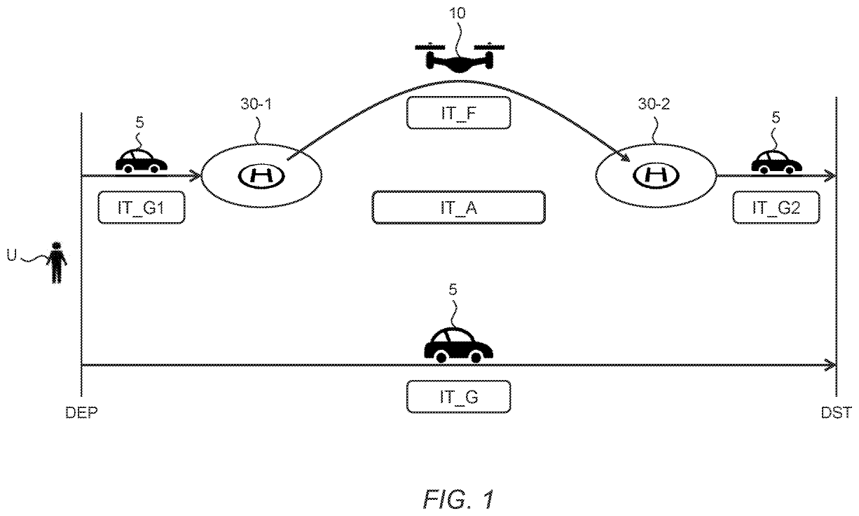

FIG. 1 is a conceptual diagram for explaining an outline of a mobility service according to the present embodiment. The mobility service utilizes a variety of mobility modes (transportation) in an integrated manner. A general mobility service utilizes a ground mobility modes 5 such as an automobile, a train, and the like. Examples of the automobile include a taxi, a bus, a ride-sharing vehicle, a MaaS vehicle, and the like.

According to the present embodiment, not only the ground mobility modes 5 but also an air mobility modes is used for the mobility service. In particular, an electric vertical takeoff and landing aircraft (eVTOL) 10 is used as the air mobility modes. Hereinafter, eVTOL means an electric vertical takeoff and landing aircraft. The eVTOL 10 is a compact and lightweight VTOL driven by an electric motor. Such the eVTOL 10 is characterized by space-saving, lower costs, and lower noise as compared with a usual aircraft. For example, the eVTOL 10 is useful for an air taxi business where movement for a relatively short distance is repeated at a high frequency.

A takeoff and landing site 30 is a place for the eVTOL 10 to take off or land. Examples of the takeoff and landing site 30 include an airport, an airdrome, a heliport, a roof of a building, an eVTOL hangar, and the like.

As a still another example, the takeoff and landing site 30 may be an auto dealer. In that case, a space for the eVTOL 10 to take off and land is provided in the grounds of the dealer. Utilizing the dealer as the takeoff and landing site 30 makes it possible to seamlessly connect the ground mobility service utilizing the automobile and the air mobility service utilizing the eVTOL 10. In addition, it enables an one-stop service providing the both mobility services. Furthermore, utilizing a dealer network makes it possible to construct a mobility service network. Similarly, the takeoff and landing site 30 may be a car rental office.

A case where a user U uses the mobility service for moving from a point of departure DEP to a destination DST as shown in FIG. 1 is considered. One option is to move from the point of departure DEP to the destination DST by using the ground mobility modes 5 such as an automobile. An itinerary using only the ground mobility modes 5 is hereinafter referred to as an “itinerary IT_G.” Another option is to move from the point of departure DEP to the destination DST by using the eVTOL 10 as well. An itinerary using the eVTOL 10 is hereinafter referred to as an “itinerary IT_A.”

An example of the itinerary IT_A is as follows. A first takeoff and landing site 30-1 is a takeoff and landing site 30 on a side of the point of departure DEP, and a second takeoff and landing site 30-2 is a takeoff and landing site 30 on a side of the destination DST. For example, the first takeoff and landing site 30-1 is a takeoff and landing site 30 nearest to the point of departure DEP, and the second takeoff and landing site 30-2 is a takeoff and landing site 30 nearest to the destination DST. The user U moves from the point of departure DEP to the first takeoff and landing site 30-1 by using the ground mobility modes 5 (itinerary IT_G1). Subsequently, the user U moves from the first takeoff and landing site 30-1 to the second takeoff and landing site 30-2 by using the eVTOL 10 (itinerary IT_F). Then, the user U moves from the second takeoff and landing site 30-2 to the destination DST by using the ground mobility modes 5 (itinerary IT_G2). The itinerary IT_A is a combination of the three itineraries IT_G1, IT_F, and IT_G2.

The user U can select a preferred one from the itinerary IT_G and the itinerary IT_A. For example, the user U selects a preferred itinerary in consideration of a required time and a usage fee. As described above, the mobility service utilizing not only the ground mobility modes 5 but also the eVTOL 10 is able to offer the user U a variety of options, which is preferable.

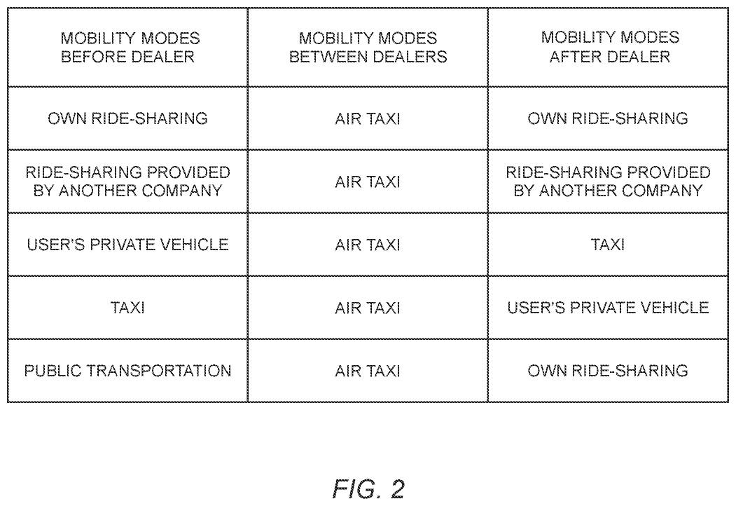

FIG. 2 shows a variety of examples of combinations of mobility modes utilizing the eVTOL 10. In the example shown in FIG. 2, the takeoff and landing site 30 is a dealer. The mobility modes between dealers (i.e., the first takeoff and landing site 30-1 and the second takeoff and landing site 30-2) is, for example, an air taxi utilizing the eVTOL 10. Examples of the mobility modes before and after the dealers include ride-sharing, a private vehicle of the user U, a taxi, a public transportation, and the like. In this manner, a variety of combinations of the mobility modes are possible.

Hereinafter, a “mobility service system” that delivers the mobility service according to the present embodiment will be described in detail.

### 2. Mobility Service System

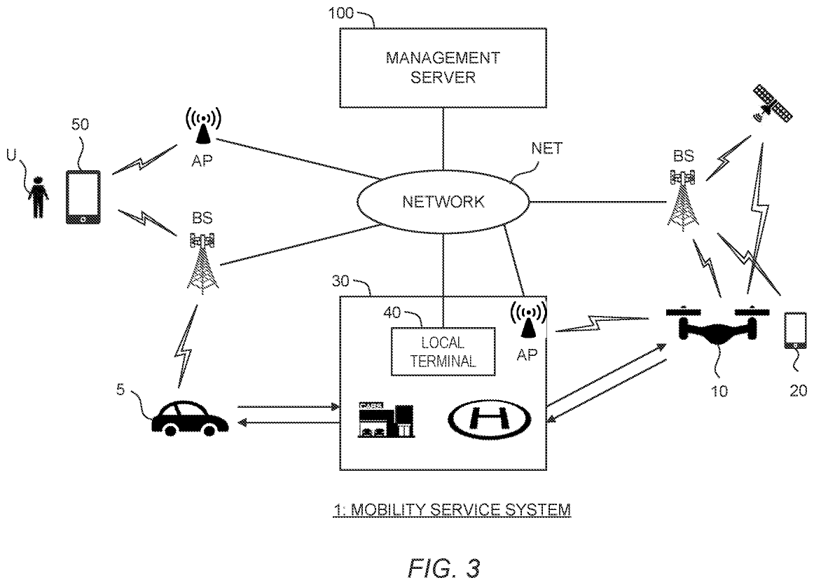

FIG. 3 is a schematic diagram showing a configuration of a mobility service system 1 according to the present embodiment. The mobility service system 1 includes the ground mobility modes 5, the eVTOL 10, a pilot terminal 20, the takeoff and landing site 30, a local terminal 40, a user terminal 50 of the user U, a management server 100 (central server), and a communication network NET. The number of eVTOLs 10 and the number of takeoff and landing sites 30 are arbitrary. For instance, a large number of eVTOLs 10 and a larger number of takeoff and landing sites 30 are utilized.

Each mobility modes and each device can be connected to the communication network NET and can communicate via the communication network NET. For example, the ground mobility modes 5 can be connected to the communication network NET via a wireless base station BS. The eVTOL 10 and the pilot terminal 20 each can be connected to the communication network NET via a wireless base station BS. The eVTOL 10 and the pilot terminal 20 each can be connected to the communication network NET via an access point AP of a wireless LAN (Local Area Network) installed in the takeoff and landing site 30. The eVTOL 10 may perform communication using satellite communication or a dedicated line. The local terminal 40 can be connected to the communication network NET by wire or via an access point AP of a wireless LAN. The user terminal 50 can be connected to the communication network NET via a wireless base station BS or an access point AP of a wireless LAN. The management server 100 can be connected to the communication network NET by wire or via an access point AP of a wireless LAN.

Hereinafter, each component of the mobility service system 1 according to the present embodiment will be described in more detail.

### 2-1. eVTOL 10

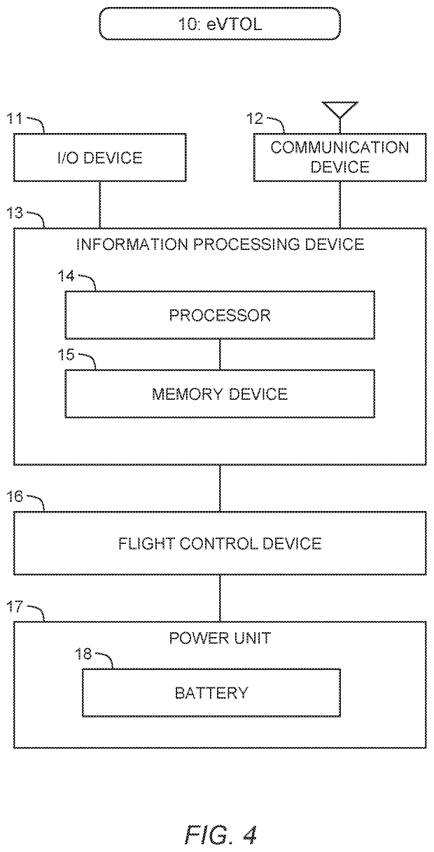

FIG. 4 is a block diagram showing a configuration example of the eVTOL 10 according to the present embodiment. The eVTOL 10 includes an input/output device 11, a communication device 12, an information processing device 13, a flight control device 16, and a power unit 17.

The input/output device 11 is an interface for receiving information from a pilot of the eVTOL 10 and for providing information to the pilot. Examples of the input device include a keyboard, a mouse, a touch panel, a switch, a microphone, and the like. Examples of the output device include a display device, a speaker, and the like.

The communication device 12 performs communication with the outside. For example, the communication device 12 performs wireless communication with the wireless base station BS and the access point AP. As another example, the communication device 12 may perform near field communication with the user terminal 50. As yet another example, during a flight of the eVTOL 10, the communication device 12 may perform communication using satellite communication or a dedicated line.

The information processing device 13 executes a variety of information processing. For example, the information processing device 13 includes one or more processors 14 and one or more memory devices 15. The processor 14 executes a variety of information processing. For example, the processor 14 includes a CPU (Central Processing Unit). The memory device 15 stores a variety of information necessary for the processing by the processor 14. Examples of the memory device 15 include a volatile memory, a non-volatile memory, an HDD (Hard Disk Drive), an SSD (Solid State Drive), and the like. Functions of the information processing device 13 are achieved by the processor 14 executing a computer program. The computer program is stored in the memory device 15. The computer program may be recorded on a computer-readable recording medium. The computer program may be provided via a network.

The flight control device 16 controls the flight of the eVTOL 10 by controlling the power unit 17.

The power unit 17 includes an electric motor for rotating a rotor of the eVTOL 10, a battery 18 for supplying electric power to the electric motor, and the like. For example, the battery 18 is a storage battery such as an all-solid-state battery and the like. Alternatively, the battery 18 may be a fuel cell. In the following description, “charging the battery 18” means “charging the storage battery”. When the eVTOL 10 is equipped with the fuel cell, “charging the battery 18” is realized by “supplying hydrogen to the fuel cell.”

### 2-2. Pilot Terminal 20

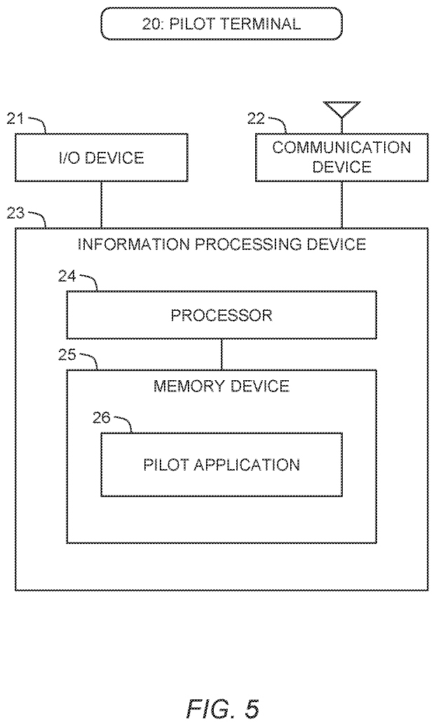

FIG. 5 is a block diagram showing a configuration example of the pilot terminal 20 according to the present embodiment. The pilot terminal 20 is a terminal used by the pilot of the eVTOL 10. For example, the pilot terminal 20 is a smartphone. The pilot terminal 20 includes an input/output device 21, a communication device 22, and an information processing device 23.

The input/output device 21 is an interface for receiving information from the pilot of the eVTOL 10 and for providing information to the pilot. Examples of the input device include a touch panel, a camera, a microphone, and the like. Examples of the output device include a display device, a speaker, and the like.

The communication device 22 performs communication with the outside. For example, the communication device 22 performs wireless communication with the wireless base station BS and the access point AP. As another example, the communication device 22 may perform near field communication with the user terminal 50.

The information processing device 23 executes a variety of information processing. For example, the information processing device 23 includes one or more processors 24 and one or more memory devices 25. The processor 24 executes a variety of information processing. For example, the processor 24 includes a CPU. The memory device 25 stores a variety of information necessary for the processing by the processor 24. Examples of the memory device 25 include a volatile memory, a non-volatile memory, and the like. Functions of the information processing device 23 are achieved by the processor 24 executing a computer program. The computer program is stored in the memory device 25. The computer program may be recorded on a computer-readable recording medium. The computer program may be provided via a network.

The computer program includes a pilot application 26. The pilot application 26 provides the pilot with functions necessary for delivering the mobility service. The functions necessary for delivering the mobility service are achieved by the processor 24 executing the pilot application 26.

### 2-3. Takeoff and Landing Site 30

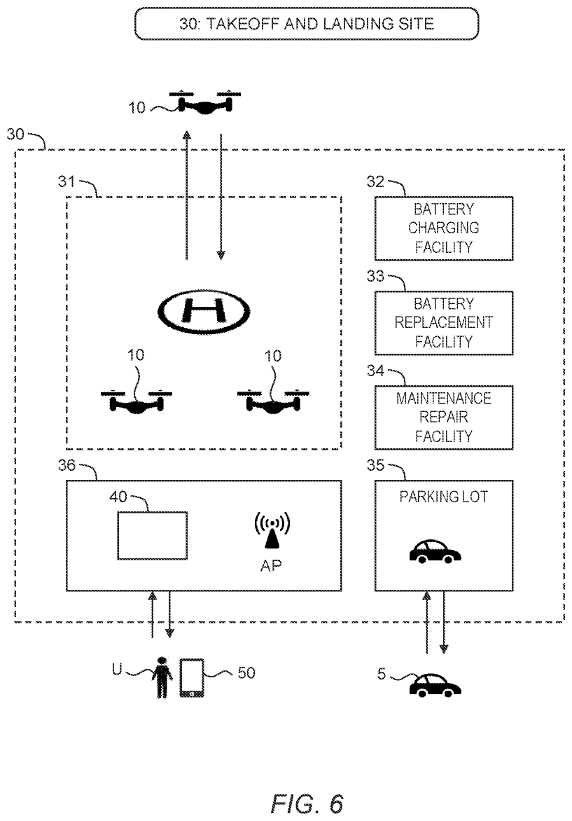

FIG. 6 is a block diagram showing a configuration example of the takeoff and landing site 30 according to the present embodiment. The takeoff and landing site 30 includes at least a takeoff and landing space 31. The takeoff and landing space 31 is a space for the eVTOL 10 to take off and land.

The takeoff and landing site 30 may include at least one of a battery charging facility 32, a battery replacement facility 33, and a maintenance/repair facility 34. The battery charging facility 32 is a facility for charging the battery 18 of the eVTOL 10. The battery replacement facility 33 is a facility for replacing the battery 18 of the eVTOL 10. The maintenance/repair facility 34 is a facility for performing maintenance and repair of the eVTOL 10.

The takeoff and landing site 30 may include a parking lot 35 for parking automobiles. The user U can access the takeoff and landing site 30 by using an automobile. The takeoff and landing site 30 may also offer a mobility service utilizing an automobile. The takeoff and landing site 30 may be an auto dealer, a car rental office, or the like.

The takeoff and landing site 30 may include a management facility 36. The management facility 36 is a facility for managing the mobility service delivered to the user U at the takeoff and landing site 30. For example, the user U checks in the eVTOL 10 at the management facility 36. As another example, at the management facility 36, the user U performs a procedure for using the ground mobility modes 5 such as the automobile. The management facility 36 may be provided with the local terminal 40, the access point AP of the wireless LAN, and the like. The local terminal 40 is a management terminal for managing the mobility service delivered to the user U at the management facility 36.

### 2-4. Local Terminal 40

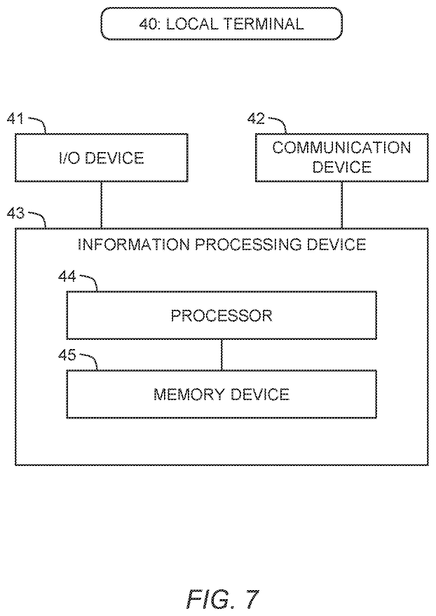

FIG. 7 is a block diagram showing a configuration example of the local terminal 40 according to the present embodiment. The local terminal 40 is a management terminal installed in the takeoff and landing site 30. The local terminal 40 includes an input/output device 41, a communication device 42, and an information processing device 43.

The input/output device 41 is an interface for receiving information from an operator of the local terminal 40 and providing information to the operator. Examples of the input device include a keyboard, a mouse, a touch panel, a switch, a microphone, and the like. Examples of the output device include a display device, a speaker, and the like.

The communication device 42 performs communication with the outside. For example, the communication device 42 performs wire communication. As another example, the communication device 42 may perform near field communication with the user terminal 50.

The information processing device 43 executes a variety of information processing. For example, the information processing device 43 includes one or more processors 44 and one or more memory devices 45. The processor 44 executes a variety of information processing. For example, the processor 44 includes a CPU. The memory device 45 stores a variety of information necessary for the processing by the processor 44. Examples of the memory device 45 include a volatile memory, a non-volatile memory, an HDD, an SSD, and the like. Functions of the information processing device 43 are achieved by the processor 44 executing a computer program. The computer program is stored in the memory device 45. The computer program may be recorded on a computer-readable recording medium. The computer program may be provided via a network.

### 2-5. User Terminal 50

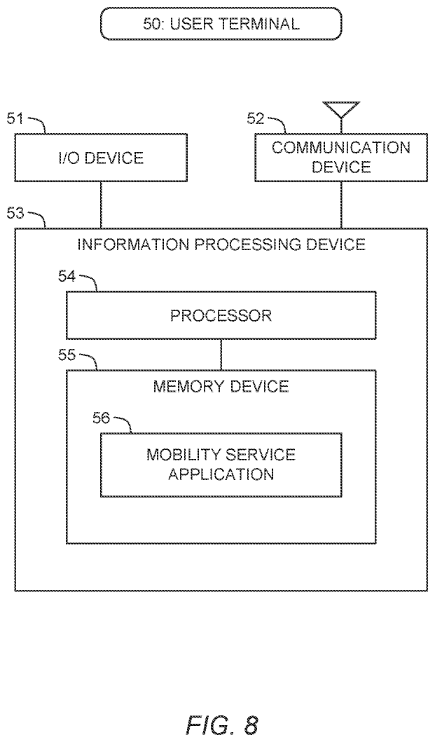

FIG. 8 is a block diagram showing a configuration example of the user terminal 50 according to the present embodiment. The user terminal 50 is a terminal used by the user U. For example, the user terminal 50 is a smartphone. The user terminal 50 includes an input/output device 51, a communication device 52, and an information processing device 53.

The input/output device 51 is an interface for receiving information from the user U and for providing information to the user U. Examples of the input device include a touch panel, a camera, a microphone, and the like. Examples of the output device include a display device, a speaker, and the like.

The communication device 52 performs communication with the outside. For example, the communication device 52 performs wireless communication with the wireless base station BS and the access point AP. As another example, the communication device 52 may perform near field communication with the pilot terminal 20 and the local terminal 40.

The information processing device 53 executes a variety of information processing. For example, the information processing device 53 includes one or more processors 54 and one or more memory devices 55. The processor 54 executes a variety of information processing. For example, the processor 54 includes a CPU. The memory device 55 stores a variety of information necessary for the processing by the processor 54. Examples of the memory device 55 include a volatile memory, a non-volatile memory, and the like. Functions of the information processing device 53 are achieved by the processor 54 executing a computer program. The computer program is stored in the memory device 55. The computer program may be recorded on a computer-readable recording medium. The computer program may be provided via a network.

The computer program includes a mobility service application 56. The mobility service application 56 provides the user U with functions necessary for utilizing the mobility service. The functions necessary for utilizing the mobility service are achieved by the processor 54 executing the mobility service application 56.

### 2-6. Management Server 100

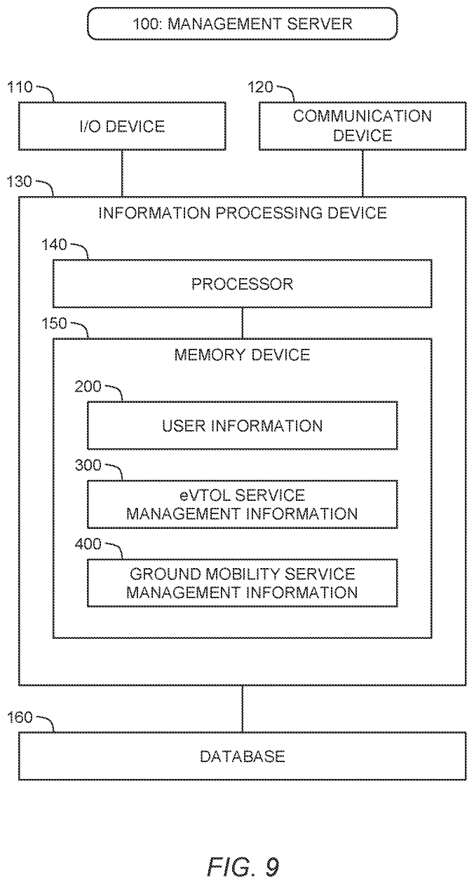

FIG. 9 is a block diagram showing a configuration example of the management server 100 according to the present embodiment. The management server 100 manages the entire mobility service and delivers the mobility service to the user U. The management server 100 may be a distributed server. The management server 100 includes an input/output device 110, a communication device 120, and an information processing device 130.

The input/output device 110 is an interface for receiving information from an operator of the management server 100 and providing information to the operator. Examples of the input device include a keyboard, a mouse, a touch panel, a switch, a microphone, and the like. Examples of the output device include a display device, a speaker, and the like.

The communication device 120 performs communication with the outside. For example, the communication device 120 performs wire communication.

The information processing device 130 executes a variety of information processing. For example, the information processing device 130 includes one or more processors 140 and one or more memory devices 150. The processor 140 executes a variety of information processing. For example, the processor 140 includes a CPU. The memory device 150 stores a variety of information necessary for the processing by the processor 140. Examples of the memory device 150 include a volatile memory, a non-volatile memory, an HDD, an SSD, and the like. Functions of the information processing device 130 are achieved by the processor 140 executing a computer program. The computer program is stored in the memory device 150. The computer program may be recorded on a computer-readable recording medium. The computer program may be provided via a network.

Moreover, the information processing device 130 is accessible to a database 160. The database 160 is realized by a predetermined memory device. The database 160 may be included in the memory device 150 of the management server 100. Alternatively, the database 160 may exist outside the management server 100. The database 160 stores a variety of information necessary for delivering the mobility service. The information processing device 130 reads necessary information from the database 160 and stores it in the memory device 150.

The information necessary for delivering the mobility service includes user information 200, eVTOL service management information 300, and ground mobility service management information 400. The information processing device 130 executes an “information acquisition process” that acquires the user information 200, the eVTOL service management information 300, and the ground mobility service management information 400.

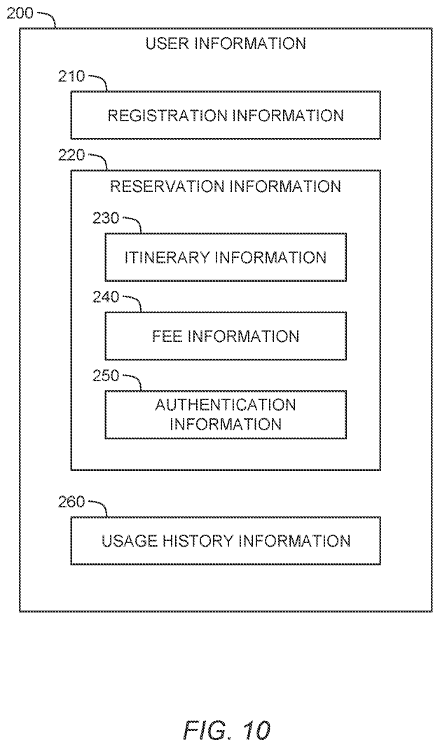

FIG. 10 is a block diagram showing an example of the user information 200. The user information 200 is information related to the user U. For example, the user information 200 includes registration information 210, reservation information 220, and usage history information 260.

The registration information 210 includes an ID and a name of the user U. The registration information 210 is registered in advance by the user U. For example, the user U operates the user terminal 50 to input the registration information 210. The user terminal 50 transmits the registration information 210 to the management server 100. The information processing device 130 receives the registration information 210 via the communication device 120, and records the registration information 210 in the database 160.

The reservation information 220 is information about the mobility service reserved by the user U. The information processing device 130 generates the reservation information 220 in response to a reservation request from the user U. Details of the reservation process will be described later.

The reservation information 220 includes at least itinerary information 230. The itinerary information 230 indicates the itinerary of the mobility service used by user U. For example, the itinerary information 230 includes a point of departure DEP, a destination DST, a route, mobility modes to be used, takeoff and landing sites 30 to be used, a time of departure, a time of arrival, a required time from the point of departure DEP to the destination DST, and the like.

The reservation information 220 may include fee information 240. The fee information 240 indicates a usage fee of the mobility service used by the user U.

The reservation information 220 may include authentication information 250. The authentication information 250 is information used for authenticating the user U when the user U boards the reserved mobility modes. The authentication information 250 includes an authentication code. The authentication information 250 may be a QR code (registered trademark).

The usage history information 260 indicates a history of the mobility service used by the user U.

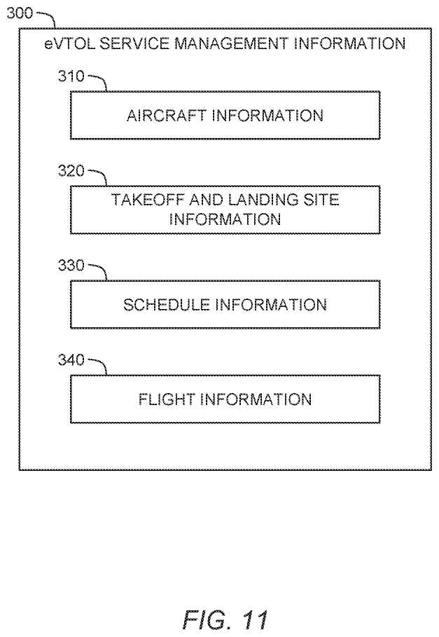

FIG. 11 is a block diagram showing an example of the eVTOL service management information 300. The eVTOL service management information 300 is information for managing the mobility service that utilizes the eVTOL 10. For example, the eVTOL service management information 300 includes aircraft information 310, takeoff and landing site information 320, schedule information 330, and flight information 340.

The aircraft information 310 is information on each of one or more eVTOLs 10 used for the mobility service. More specifically, the aircraft information 310 includes an aircraft ID, performance information, and the like of each eVTOL 10. The performance information includes a flight range, a maximum flight speed, and the like. The flight range is the maximum distance for which the eVTOL 10 is able to fly without being charged halfway. In addition, the performance information includes “battery performance information” regarding performance of the battery 18 of the eVTOL 10. The battery performance information includes a maximum battery capacity, a remaining battery level, a charging time required to charge the battery 18 to full capacity, and the like. Furthermore, the battery performance information indicates whether the eVTOL 10 is an aircraft whose battery 18 is replaceable.

The takeoff and landing site information 320 is information on each of one or more takeoff and landing sites 30 used for the mobility service. More specifically, the takeoff and landing site information 320 includes a location (latitude and longitude) of each takeoff and landing site 30. In addition, the takeoff and landing site information 320 includes a facility ability of each takeoff and landing site 30. For example, the takeoff and landing site information 320 indicates presence or absence of the battery charging facility 32, presence or absence of the battery replacement facility 33, presence or absence of the maintenance/repair facility 34, presence or absence of the parking lot 35, and the like (see FIG. 6).

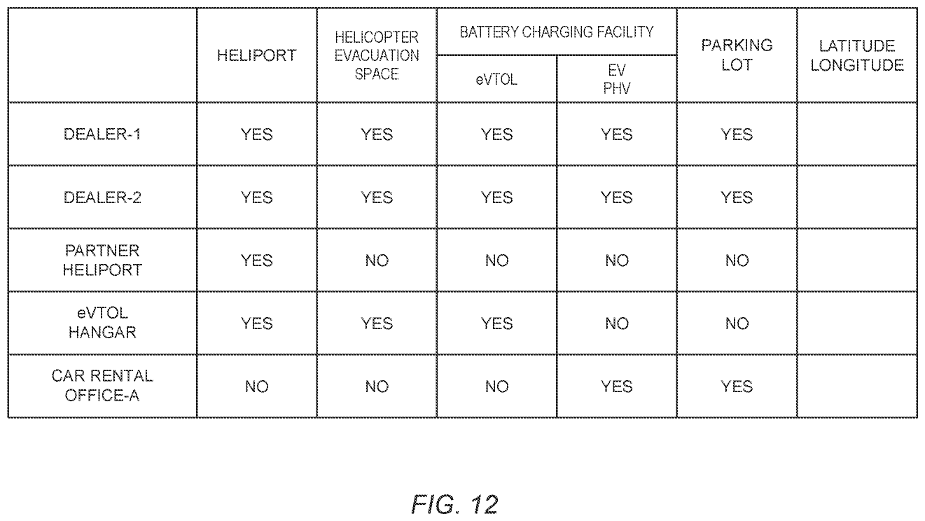

FIG. 12 shows an example of the takeoff and landing site information 320. Examples of the takeoff and landing site 30 include a dealer, a partner heliport, an eVTOL hangar, and a car rental office. The takeoff and landing site information 320 indicates presence or absence of a heliport, presence or absence of a helicopter evacuation space, presence or absence of the battery charging facility 32, presence or absence of the parking lot 35, and the latitude/longitude, for each takeoff and landing site 30.

The schedule information 330 includes at least one of a schedule of each eVTOL 10 and a schedule of each takeoff and landing site 30. The schedule of each eVTOL 10 indicates when and where each eVTOL 10 exists. For example, the schedule of each eVTOL 10 indicates a period of time when each eVTOL 10 exists at a takeoff and landing site 30, the takeoff and landing site 30, a period of time when each eVTOL 10 is in flight, a period of time when each eVTOL 10 is under maintenance, and the like. The schedule of each takeoff and landing site 30 indicates when and which eVTOL 10 is present (available) at each takeoff and landing site 30. In addition, the schedule of each takeoff and landing site 30 indicates a usage schedule and availability of the battery charging facility 32, the battery replacement facility 33, the maintenance/repair facility 34, and the like.

The flight information 340 is information on a flight of the eVTOL 10. For example, the flight information 340 includes a flight route, a position, an altitude, a flight speed, and the like of the eVTOL 10. Such the flight information 340 may be acquired in real time during the flight or may be acquired after the flight. In either case, the past flight information 340 is recorded in the database 160.

The ground mobility service management information 400 is information for managing the mobility service that utilizes the ground mobility modes 5. More specifically, the ground mobility service management information 400 indicates a type and a schedule of the ground mobility modes 5. For example, when the ground mobility modes 5 is an automobile, the ground mobility service management information 400 indicates an ID, a vehicle type, a schedule (e.g., a location, a usage status, a reservation status), and the like of the automobile.

### 3. Reservation Process

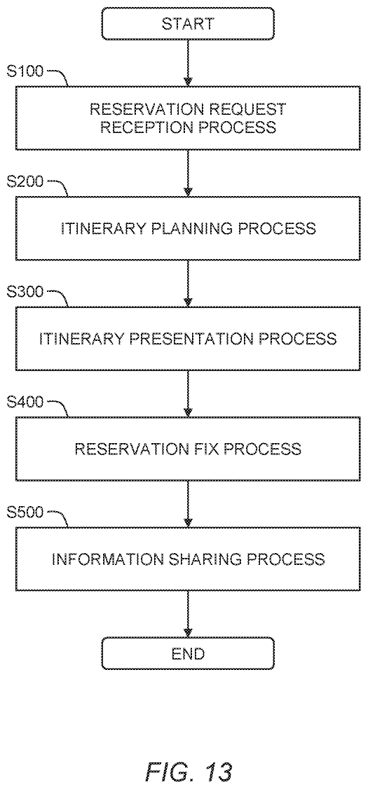

The management server 100 (i.e., the information processing device 130) according to the present embodiment executes a “reservation process” that accepts a reservation of the mobility service requested from the user U. FIG. 13 is a flow chart showing the reservation process. Hereinafter, the reservation process according to the present embodiment will be described in detail. It should be noted that the eVTOL service management information 300 and the ground mobility service management information 400 are already acquired by the above-described information acquisition process and stored in the database 160 and the memory device 150.

### 3-1. Step S100 (Reservation Request Reception Process)

First, the information processing device 130 executes a “reservation request reception process” that receives a reservation request REQ from the user U. For example, the reservation request REQ includes a desired date of usage, a desired time of departure, a desired time of arrival, a point of departure DEP, a destination DST, and the like. The reservation request REQ may specify a desired mobility modes (e.g., eVTOL 10). The reservation request REQ corresponds to “search information” used by the user U for searching for the mobility service.

The user U inputs the reservation request REQ (i.e., the search information) by the use of the input/output device 51 of the user terminal 50. The information processing device 53 of the user terminal 50 transmits the input reservation request REQ to the management server 100 via the communication device 52. The information processing device 130 of the management server 100 receives the reservation request REQ via the communication device 120. The information processing device 130 stores the received reservation request REQ in the memory device 150.

### 3-2. Step S200 (Itinerary Planning Process)

In response to the reservation request REQ, the information processing device 130 executes an “itinerary planning process” that plans an itinerary from the point of departure DEP to the destination DST. The itinerary planning process is executed based on the eVTOL service management information 300 and the ground mobility service management information 400 described above.

### 3-2-1. First Example

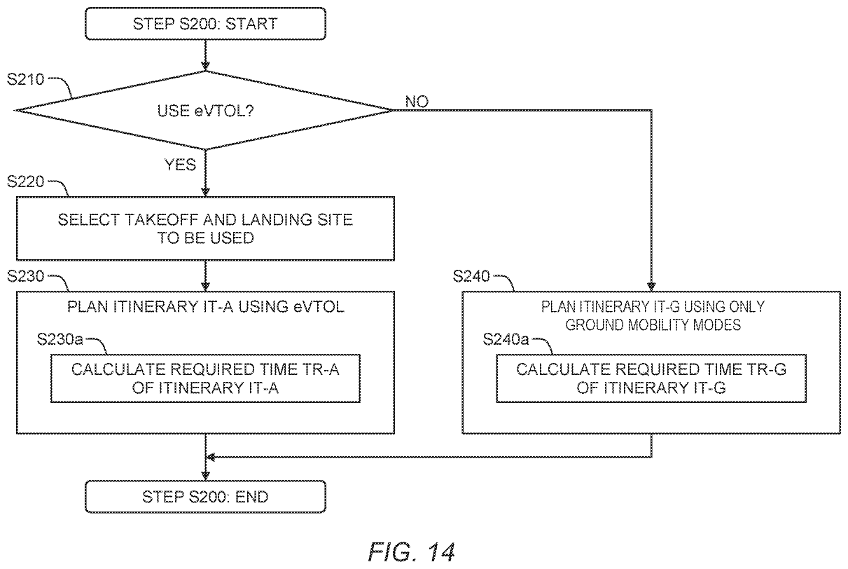

FIG. 14 is a flow chart showing a first example of the itinerary planning process (Step S200).

In Step S210, the information processing device 130 determines whether or not the reservation request REQ specifies the use of the eVTOL 10. In other words, the information processing device 130 determines whether or not the user U desires to use the eVTOL 10. When the use of the eVTOL 10 is specified (Step S210; Yes), the processing proceeds to Step S220. On the other hand, when the use of the eVTOL 10 is not specified (Step S210; No), the processing proceeds to Step S240.

In Step S220, the information processing device 130 selects the takeoff and landing sites 30 to be used. As described in FIG. 1, the first takeoff and landing site 30-1 is a takeoff and landing site 30 on the side of the point of departure DEP, and the second takeoff and landing site 30-2 is a takeoff and landing site 30 on the side of the destination DST. For example, the information processing device 130 sets a takeoff and landing site 30 nearest to the point of departure DEP as the first takeoff and landing site 30-1, and sets a takeoff and landing site 30 nearest to the destination DST as the second takeoff and landing site 30-2. The location (latitude and longitude) of each takeoff and landing site 30 is included in the takeoff and landing site information 320. Therefore, the information processing device 130 can select (set) the takeoff and landing sites 30 to be used, based on the takeoff and landing site information 320 and the point of departure DEP and the destination DST indicated by the reservation request REQ.

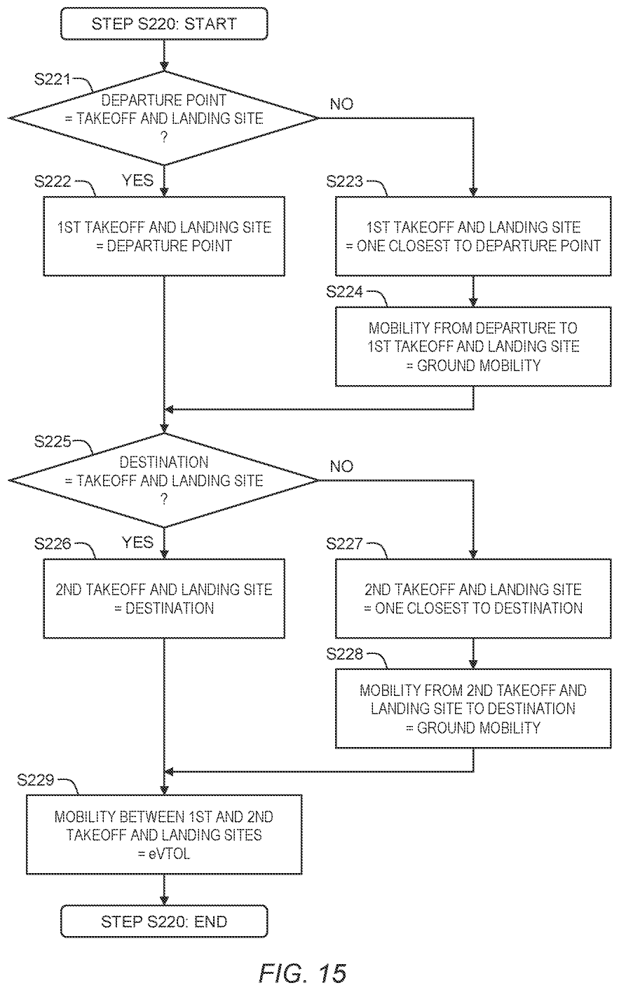

FIG. 15 is a flow chart showing an example of Step S220.

In Step S221, the information processing device 130 determines whether or not the point of departure DEP is any takeoff and landing site 30. When the point of departure DEP is any takeoff and landing site 30 (Step S221; Yes), the information processing device 130 sets the point of departure DEP as the first takeoff and landing site 30-1 (Step S222). On the other hand, when the point of departure DEP is not a takeoff and landing site 30 (Step S221; No), the information processing device 130 sets a takeoff and landing site 30 nearest to the point of departure DEP as the first takeoff and landing site 30-1 (Step S223). In other words, the information processing device 130 adds the takeoff and landing site 30 nearest to the point of departure DEP as a transfer point. Then, the information processing device 130 sets the mobility modes from the point of departure DEP to the first takeoff and landing site 30-1 to the ground mobility modes 5 such as an automobile (Step S224).

In Step S225, the information processing device 130 determines whether or not the destination DST is any takeoff and landing site 30. When the destination DST is any takeoff and landing site 30 (Step S225; Yes), the information processing device 130 sets the destination DST as the second takeoff and landing site 30-2 (Step S226). On the other hand, when the destination DST is not a takeoff and landing site 30 (Step S225; No), the information processing device 130 sets a takeoff and landing site 30 nearest to the destination DST as the second takeoff and landing site 30-2 (Step S227). In other words, the information processing device 130 adds the takeoff and landing site 30 nearest to the destination DST as a transfer point. Then, the information processing device 130 sets the mobility modes from the second takeoff and landing site 30-2 to the destination DST to the ground mobility modes 5 such as an automobile (Step S228).

In Step S229, the information processing device 130 sets the mobility modes from the first takeoff and landing site 30-1 to the second takeoff and landing site 30-2 to the eVTOL 10. After that, the processing proceeds to Step S230.

In Step S230, the information processing device 130 plans (creates) the “itinerary IT_A” that uses the eVTOL 10. The itinerary IT_A includes a flight from the first takeoff and landing site 30-1 to the second takeoff and landing site 30-2. For example, the itinerary IT_A is a combination of the itinerary IT_G1 to move from the point of departure DEP to the first takeoff and landing site 30-1 by the ground mobility modes 5, the itinerary IT_F to move from the first takeoff and landing site 30-1 to the second takeoff and landing site 30-2 by the eVTOL 10, and the itinerary IT_G2 to move from the second takeoff and landing site 30-2 to the destination DST by the ground mobility modes 5 (see FIG. 1). The information processing device 130 can plan the itinerary IT_A based on the eVTOL service management information 300 (especially, the schedule information 330) and the ground mobility service management information 400.

In addition, in Step S230, the information processing device 130 calculates a required time TR-A from the point of departure DEP to the destination DST in the case of the itinerary IT-A (Step S230a).

On the other hand, in Step S240, the information processing device 130 plans (creates) the “itinerary IT_G” that uses only the ground mobility modes 5 (see FIG. 1). The information processing device 130 can plan the itinerary IT_G based on the ground mobility service management information 400.

In addition, in Step S240, the information processing device 130 calculates a required time TR-G from the point of departure DEP to the destination DST in the case of the itinerary IT-G (Step S240a).

### 3-2-2. Second Example

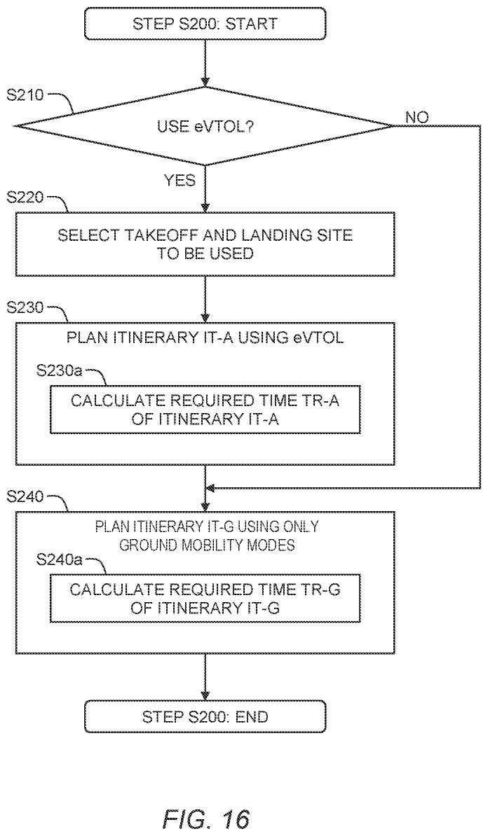

FIG. 16 is a flow chart showing a second example of the itinerary planning process (Step S200). An overlapping description with the first example described in FIG. 14 will be omitted. When the use of the eVTOL 10 is specified (Step S210; Yes), only the itinerary IT-A is planned in the case of the first example, but in the second example, both the itinerary IT_A and the itinerary IT_G are planned. To that end, Step S240 is performed after Step S230. Since both the itinerary IT_A and the itinerary IT_G are planned, it is possible in an itinerary presentation process (Step S300) described later to present both the itinerary IT_A and the itinerary IT_G such that the user U is able to compare them.

### 3-2-3. Third Example

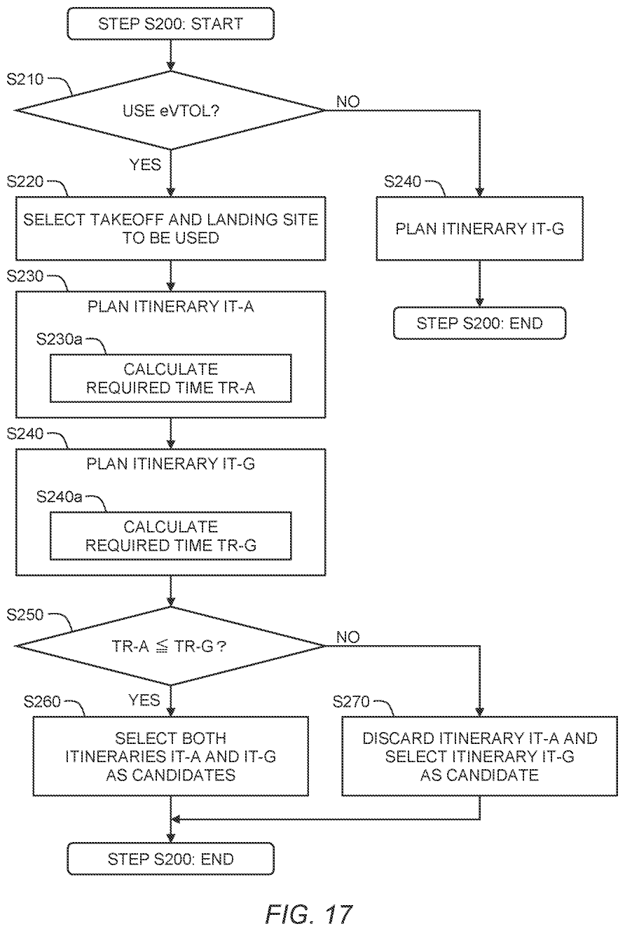

FIG. 17 is a flow chart showing a third example of the itinerary planning process (Step S200). The third example is a modification example of the second example shown in FIG. 16. As described above, when the use of the eVTOL 10 is specified (Step S210; Yes), the information processing device 130 plans both the itinerary IT-A and the itinerary IT-G (Steps S230 and S240). Furthermore, in Step S250, the information processing device 130 compares the required time TR-A of the itinerary IT-A and the required time TR-G of the itinerary IT-G. When the required time TR-A is equal to or less than the required time TR-G (Step S250; Yes), the information processing device 130 selects both the itinerary IT-A and the itinerary IT-G as candidates (Step S260). On the other hand, when the required time TR-A is longer than the required time TR-G (Step S250; No), the information processing device 130 discards the itinerary IT-A and selects the itinerary IT-G as a candidate (Step S270).

### 3-2-4. Itinerary Information

The itinerary information 230 indicates the itinerary planned by the itinerary planning process. For example, the itinerary information 230 includes the point of departure DEP, the destination DST, the route, the mobility modes to be used, the takeoff and landing sites 30 to be used, the time of departure, the time of arrival, the required time from the point of departure DEP to the destination DST, and the like. The information processing device 130 stores the generated itinerary information 230 in the memory device 150.

The information processing device 130 may further generate the fee information 240 together with the itinerary information 230. The fee information 240 indicates the usage fee when the mobility service of the generated itinerary is used. The information processing device 130 stores the generated fee information 240 in the memory device 150.

### 3-3. Step S300 (Itinerary Presentation Process)

After the itinerary information 230 is generated by the itinerary planning process (Step S200), the information processing device 130 executes an “itinerary presentation process” that presents the itinerary information 230 to the user U.

More specifically, the information processing device 130 transmits the itinerary information 230 to the user terminal 50 via the communication device 120. The information processing device 53 of the user terminal 50 receives the itinerary information 230 via the communication device 52. The information processing device 53 stores the itinerary information 230 in the memory device 55. Moreover, the information processing device 53 presents the itinerary information 230 to the user U through the input/output device 51. Typically, the itinerary information 230 is displayed on the display device.

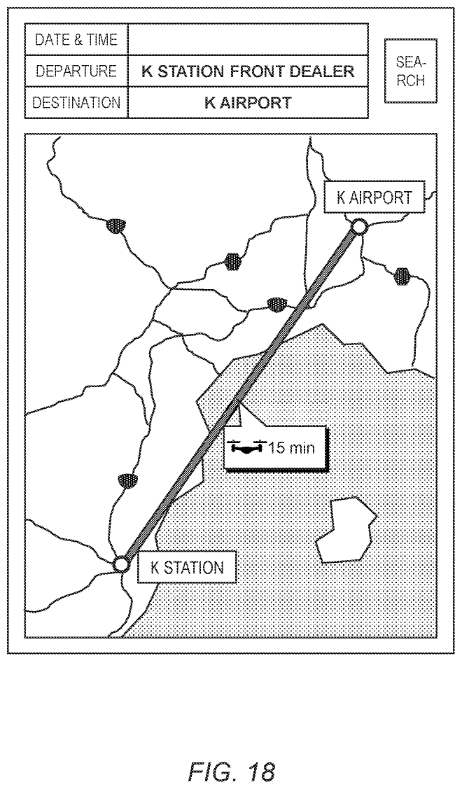

FIG. 18 is a conceptual diagram showing an example of information displayed on the display device. For simplicity, it is assumed that the point of departure DEP is the first takeoff and landing site 30-1 (e.g., K Station Front Dealer) and the destination DST is the second takeoff and landing site 30-2 (e.g., K Airport). In the example shown in FIG. 18, information of the itinerary IT_A utilizing the eVTOL 10 is displayed on the display device. More specifically, a map, the point of departure DEP, the destination DST, the route, the mobility modes (i.e., the eVTOL 10), and the required time TR-A (e.g., 15 minutes) from the point of departure DEP to the destination DST are displayed.

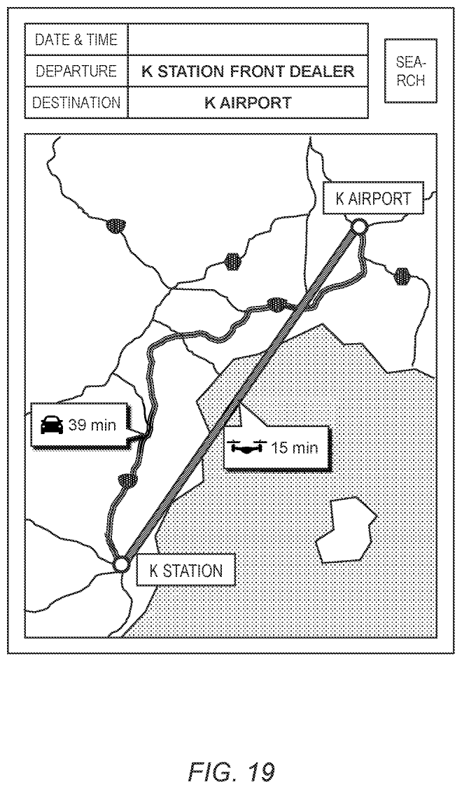

FIG. 19 is a conceptual diagram showing another example of information displayed on the display device. In the example shown in FIG. 19, information of both the itinerary IT_A and the itinerary IT_G is displayed. For example, in the case of the itinerary IT_G, the automobile is utilized and the required time TR-G from the point of departure DEP to the destination DST is 39 minutes. The user U can make a comparison of the itinerary IT_A and the itinerary IT_G.

As yet another example, only the itinerary with the shorter required time may be selectively displayed. In the same situation as shown in FIG. 19, only the information of the itinerary IT_A is selectively displayed. The information processing device 130 of the management server 100 may selectively transmit only the itinerary information 230 having the shorter required time to the user terminal 50. Alternatively, the information processing device 53 of the user terminal 50 may select the itinerary information 230 having the shorter required time.

The information processing device 130 may present the fee information 240 together with the itinerary information 230 to the user U. A method of presenting the fee information 240 is the same as in the case of the itinerary information 230.

### 3-4. Step S400 (Reservation Fix Process)

The user U considers the presented itinerary information 230 to determine whether or not to fix the reservation. When multiple itineraries are presented, the user U selects one from the multiple itineraries. For example, the user U makes a decision and choice by referring to the required time and the usage fee. When not approving the presented itinerary information 230, the user U may change the reservation request REQ. In that case, the processing returns to Step S100.

When fixing the reservation, the user U uses the input/output device 51 of the user terminal 50 to instruct to fix the reservation. When multiple itineraries are presented, the user U specifies one of the multiple itineraries. The information processing device 53 of the user terminal 50 transmits a reservation fix request to the management server 100 via the communication device 52. The information processing device 130 of the management server 100 receives the reservation fix request via the communication device 120.

In response to the reservation fix request, the information processing device 130 fixes the itinerary information 230 and the fee information 240. In addition, the information processing device 130 generates the authentication information 250. Then, the information processing device 130 generates the reservation information 220 including the itinerary information 230, the fee information 240, and the authentication information 250 (see FIG. 10). The information processing device 130 stores the reservation information 220 in the memory device 150.

Further, the information processing device 130 updates the schedule information 330 by reflecting the fixed itinerary information 230 in the schedule information 330. That is, the information processing device 130 reflects the schedules of the eVTOL 10 and the takeoff and landing sites 30 used in the fixed itinerary in the schedule information 330.

### 3-5. Step S500 (Information Sharing Process)

The information processing device 130 of the management server 100 transmits the reservation information 220 to the user terminal 50 via the communication device 120. The information processing device 53 of the user terminal 50 receives the reservation information 220 via the communication device 52. The information processing device 53 stores the reservation information 220 in the memory device 55.

The information processing device 130 of the management server 100 may transmit the user information 200 including the name of the user U, the user ID, and the itinerary information 230 to the reserved eVTOL 10. The information processing device 13 of the reserved eVTOL 10 receives the user information 200 via the communication device 12. The information processing device 13 stores the user information 200 in the memory device 15.

Similarly, the information processing device 130 of the management server 100 may transmit the user information 200 to the pilot terminal 20 used by the pilot of the reserved eVTOL 10. The information processing device 23 of the pilot terminal 20 receives the user information 200 via the communication device 22. The information processing device 23 stores the user information 200 in the memory device 25.

Similarly, the information processing device 130 of the management server 100 may transmit the user information 200 to the local terminal 40 installed in the reserved takeoff and landing site 30. The information processing device 43 of the local terminal 40 receives the user information 200 via the communication device 42. The information processing device 43 stores the user information 200 in the memory device 45.

### 4. Check-In Process (Pick Up)

At the first takeoff and landing site 30-1, the eVTOL 10 picks up the user U. That is, at the first takeoff and landing site 30-1, the user U boards the reserved eVTOL 10. After the user U boards the eVTOL 10, the eVTOL 10 takes off.

Before the boarding, a “user authentication process” that authenticates the user U may be performed. As an example, the user authentication process performed by the pilot terminal 20 and the management server 100 will be described. The same applies to a case where the eVTOL 10 or the local terminal 40 is used instead of the pilot terminal 20.

First, the user U provides the pilot terminal 20 with the authentication information 250 stored in the user terminal 50. For example, the communication device 52 of the user terminal 50 and the communication device 22 of the pilot terminal 20 perform the near field communication, and thereby the authentication information 250 is transmitted from the user terminal 50 to the pilot terminal 20. As another example, in a case where the authentication information 250 is a QR code, the user U may display the QR code on the display device. In this case, the camera or the like of the pilot terminal 20 reads the QR code displayed on the display device of the user terminal 50.

The information processing device 23 of the pilot terminal 20 transmits the acquired authentication information 250 to the management server 100. The information processing device 130 of the management server 100 authenticates the user U by checking the received authentication information 250 against the reservation information 220 stored in the memory device 150. Then, the information processing device 130 transmits the authentication result to the pilot terminal 20. The information processing device 23 of the pilot terminal 20 receives the authentication result. Alternatively, when the pilot terminal 20 holds the reservation information 220, the information processing device 23 may authenticate the user U by checking the authentication information 250 against the reservation information 220.

### 5. Flight Route Determination Process

### 5-1. Outline

Next, a method of determining an appropriate flight route of the eVTOL 10 in the mobility service utilizing the eVTOL 10 will be described.

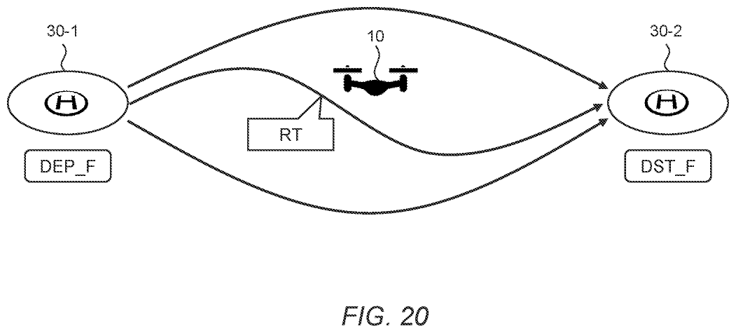

FIG. 20 conceptually illustrates a flight utilizing the eVTOL 10. The eVTOL 10 flies from a first takeoff and landing site 30-1 to a second takeoff and landing site 30-2. That is, the first takeoff and landing site 30-1 is a point of departure DEP_F of the flight, and the second takeoff and landing site 30-2 is a destination DST_F of the flight. There can be various flight routes RT from the point of departure DEP_F to the destination DST_F. For example, the flight route RT may vary depending on experience of the pilot of the eVTOL 10. An object is to determine an appropriate one from such a variety of candidates of the flight route RT.

According to the present embodiment, an appropriate flight route RT is determined in terms of (1) meeting a safety criterion and a noise criterion, and (2) a high energy efficiency. The energy efficiency (electric economy) being high means less energy consumption of the eVTOL 10 during the flight.

The safety criterion demands a certain margin or more between the eVTOL 10 and obstacles in order to prevent the eVTOL 10 from coming into contact with obstacles such as buildings and terrains. The noise criterion demands a flight altitude that can suppress a noise level on the ground caused by the flight of the eVTOL 10 to be a certain level or less. A zone (region) into which the eVTOL 10 is recommended to refrain from intruding in terms of the safety criterion and the noise criterion is hereinafter referred to as an “intrusion avoidance zone ZX.” It can be said that the intrusion avoidance zone ZX is a zone that does not meet at least one of the safety criterion and the noise criterion. Such the intrusion avoidance zone ZX is set in advance based on three-dimensional terrain data. The intrusion avoidance zone ZX may be set two-dimensionally or may be set three-dimensionally. When the eVTOL 10 flies in a zone other than the intrusion avoidance zone ZX, both the safety criterion and the noise criterion are met.

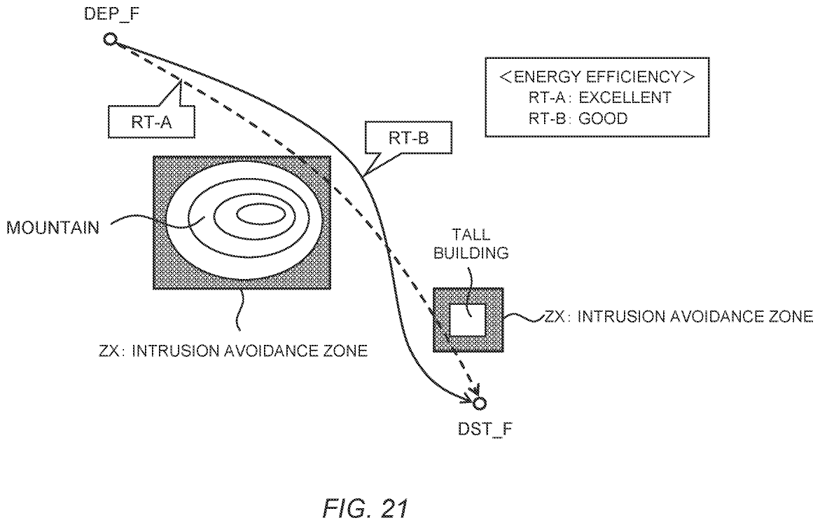

FIG. 21 is a conceptual diagram illustrating an example of the intrusion avoidance zones ZX and the flight routes RT. In FIG. 21, two kinds of flight routes RT-A and RT-B are illustrated as examples of the flight route RT from the point of departure DEP_F to the destination DST_F. In addition, a mountain and a tall building are illustrated as examples of the obstacles. The intrusion avoidance zone ZX is set around each obstacle.

The flight route RT-A connects between the point of departure DEP_F and the destination DST_F in a short distance, and thus the energy efficiency in the case of the flight along the flight route RT-A is excellent. However, the flight route RT-A passes through the intrusion avoidance zone ZX and thus does not meet the safety criterion and the noise criterion. On the other hand, the flight route RT-B avoids the intrusion avoidance zone ZX and thus meets the safety criterion and the noise criterion. However, the flight route RT-B is longer than the flight route RT-A, and thus the energy efficiency in the case of the flight along the flight route RT-B is lower than that in the case of the flight route RT-A. In this example, the flight route RT-B is more appropriate flight route RT than the flight route RT-A. That is, a flight route RT that does not intrude into the intrusion avoidance zone ZX and has a high energy efficiency is the appropriate flight route RT.

In order to determine an appropriate flight route RT from the above point of view, a “flight database” regarding past flights utilizing the eVTOL 10 is prepared. The flight database stores flight record information regarding past flights utilizing the eVTOL 10.

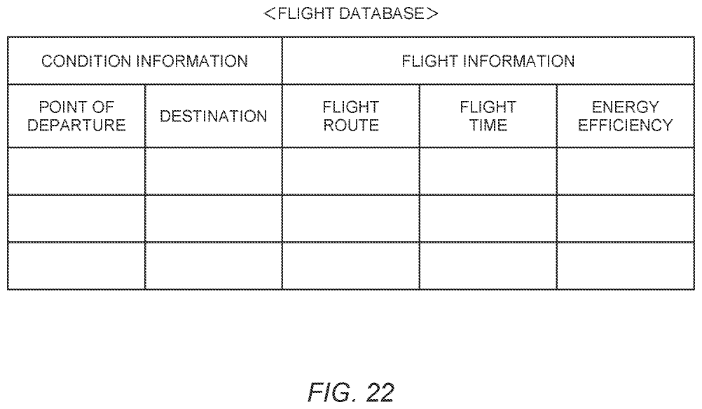

FIG. 22 is a conceptual diagram showing an example of the flight database. The flight database includes flight record information regarding each past flight. The flight record information regarding each past flight at least indicates a correspondence relationship between a combination of the point of departure DEP_F and the destination DST_F, a flight route, a flight time, and an energy efficiency. The flight route is defined by a latitude, a longitude, and an altitude. For the purpose of convenience, information including the combination of the point of departure DEP_F and the destination DST_F is hereinafter referred to as “condition information.” On the other hand, information including the flight route, the flight time, and the energy efficiency is hereinafter referred to as “flight information.” It can be said that the flight record information indicates a correspondence relationship between the condition information and the flight information. When a certain combination of the point of departure DEP_F and the destination DST_F is given as the condition information, it is possible to extract past flight information matching the given condition information from the flight database.

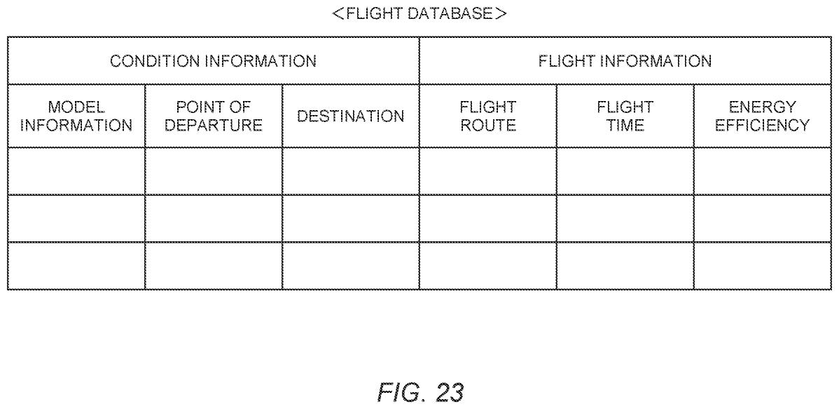

FIG. 23 is a conceptual diagram showing another example of the flight database. In the example shown in FIG. 23, a case where the eVTOLs 10 of multiple models (types) are used is considered. The condition information of the flight record information further includes model information of the eVTOL 10 used in the past flight, in addition to the combination of the point of departure DEP_F and the destination DST_F. When a certain combination of the point of departure DEP_F and the destination DST_F and a certain model are given as the condition information, it is possible to extract past flight information matching the given condition information from the flight database.

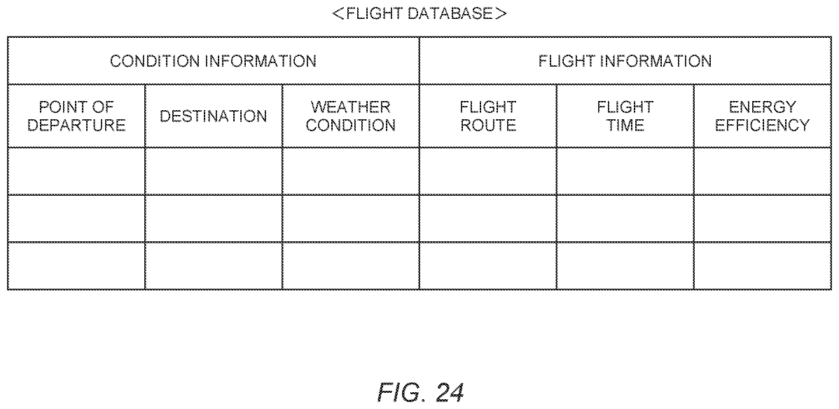

FIG. 24 is a conceptual diagram showing still another example of the flight database. In the example shown in FIG. 24, the condition information of the flight record information further includes a weather condition at the time of the past flight, in addition to the combination of the point of departure DEP_F and the destination DST_F. For example, the weather condition includes weather (sunny, cloudy, rainy, foggy, etc.), a wind speed, and a wind direction. When a certain combination of the point of departure DEP_F and the destination DST_F and a certain weather condition are given as the condition information, it is possible to extract past flight information matching the given condition information from the flight database.

A combination of FIG. 23 and FIG. 24 also is possible. That is, the condition information of the flight record information may include the combination of the point of departure DEP_F and the destination DST_F, the model information, and the weather condition.

According to the present embodiment, the flight database and information on the intrusion avoidance zone ZX described above are used when determining a flight route RT of a new flight. For the purpose of convenience, the new flight is hereinafter referred to as a “first flight F1.” The point of departure DEP_F and the destination DST_F of the first flight F1 are hereinafter referred to as a “first point of departure DEP_F1” and a “first destination DST_F1”, respectively. The eVTOL 10 used for the first flight F1 is hereinafter referred to as a “first eVTOL 10-1.” The flight route RT of the first flight F1 is hereinafter referred to as a “target flight route RT1.” According to the present embodiment, one with a highest energy efficiency among past flight routes RT that are from the first point of departure DEP_F1 to the first destination DST_F1 and do not intrude into the intrusion avoidance zone ZX is determined (selected) as the target flight route RT1 of the first flight F1.

For example, in the case of the flight database shown in FIG. 22, the condition information includes the point of departure DEP and the destination DST. In this case, the flight record information (entry) including a combination of the first point of departure DEP_F1 and the first destination DST_F1 as the condition information is extracted from the flight database. Further, one with the highest energy efficiency among the extracted flight record information is selected. The flight route indicated by the single flight record information selected is the target flight route RT1.

As another example, in the case of the flight database shown in FIG. 23, the condition information includes the model information in addition to the combination of the point of departure DEP_F and the destination DST_F. In this case, the flight record information (entry) including, as the condition information, not only the combination of the first point of departure DEP_F1 and the first destination DST_F1 but also the same model as the first eVTOL 10-1 is extracted from the flight database. Further, one with the highest energy efficiency among the extracted flight record information is selected. The flight route indicated by the single flight record information selected is the target flight route RT1.

As still another example, in the case of the flight database shown in FIG. 24, the condition information includes the weather condition in addition to the combination of the point of departure DEP_F and the destination DST_F. In this case, the flight record information (entry) including, as the condition information, not only the combination of the first point of departure DEP_F1 and the first destination DST_F1 but also the weather condition similar to an expected weather condition at the time of the first flight F1 is extracted from the flight database. The expected weather condition at the time of the first flight F1 is obtained from general weather information. Two weather conditions being similar to each other means that a degree of similarity of the two weather conditions is equal to or more than a threshold. The degree of similarity of the two weather conditions is calculated, for example, by a predetermined formula or a predetermined model that is based on differences in weather, wind speed, and wind direction. Then, one with the highest energy efficiency among the extracted flight record information is selected. The flight route indicated by the single flight record information selected is the target flight route RT1.

According to the present embodiment, as described above, it is possible to determine an appropriate target flight route RT1 in terms of the energy efficiency and the intrusion avoidance zone ZX, in the mobility service utilizing the eVTOL 10.

The above-described process of determining the target flight route RT1 of the first flight F1 is hereinafter referred to as a “flight route determination process.” A subject (execution device) of the flight route determination process is typically the management server 100, but not limited thereto. The subject of the flight route determination process is arbitrary as long as it is able to access the flight database. For example, the first eVTOL 10-1 itself may access the flight database to execute the flight route determination process. The flight route determination process may be executed by a plurality of devices in a distributed manner. To generalize, the flight route determination process is executed by one or more processors. Information necessary for the flight route determination process is stored in one or more memories.

### 5-2. Configuration Example of eVTOL

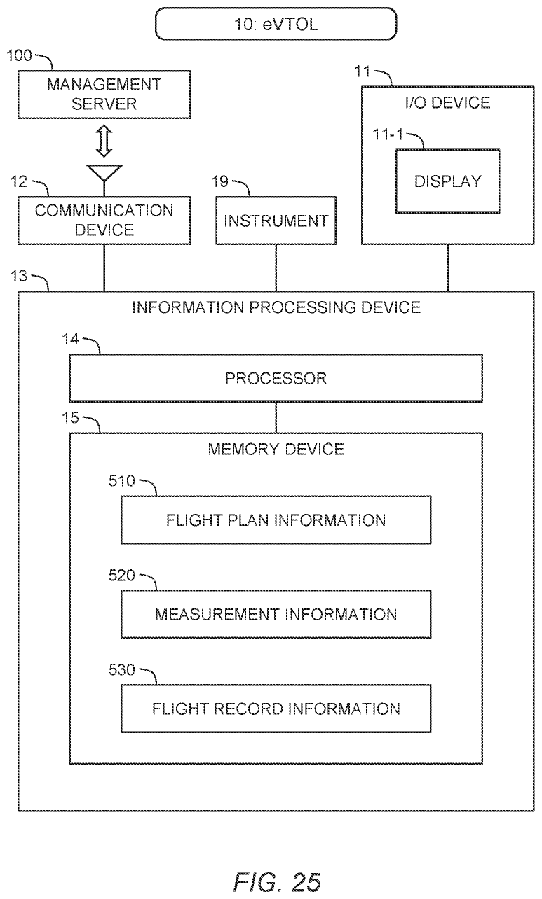

FIG. 25 is a block diagram showing a configuration example of the eVTOL 10. An overlapping description with the above-described Section 2-1 and FIG. 4 will be omitted as appropriate. The eVTOL 10 is equipped with the input/output device 11, the communication device 12, the information processing device 13, and an instrument 19.

The instrument 19 measures the latitude, the longitude, the altitude, the flight speed, and so forth. For example, the instrument 19 includes a GNSS (Global Navigation Satellite System), an altimeter, a speed meter, and so forth.

Flight plan information 510, measurement information 520, and flight record information 530 are stored in the memory device 15 of the information processing device 13.

The flight plan information 510 includes the point of departure DEP_F, the destination DST_F, the target flight route, and so forth. The information processing device 13 (i.e., the processor 14) communicates with the management server 100 through the communication device 12 to receive the flight plan information 510 from the management server 100. Then, the information processing device 13 displays the flight plan information 510 on a display 11-1 of the input/output device 11. The pilot of the eVTOL 10 operates the eVTOL 10 while watching the flight plan information 510 displayed on the display 11-1. In particular, the pilot operates the eVTOL 10 so as to fly along the target flight route.

The measurement information 520 is information measured by the instrument 19 during the flight. The measurement information 520 includes the latitude, the longitude, the altitude, the flight speed, and so forth during the flight.

The flight record information 530 indicates a record regarding the flight. The flight record information 530 includes the point of departure DEP_F, the destination DST_F, the model information, the weather condition, the flight route, the flight time, the energy efficiency, and so forth. The point of departure DEP_F and the destination DST_F are obtained from the flight plan information 510. The model information is known information inherent to the eVTOL 10. The weather condition is obtained from weather information. The weather information is obtained, for example, by communicating with a weather information service server through the communication device 12. The flight route and the flight time are obtained from a history of the measurement information 520. The energy efficiency can be calculated from a status of the battery 18 (see FIG. 4). The information processing device 13 (i.e., the processor 14) communicates with the management server 100 through the communication device 12. After completion of the flight or during the flight, the information processing device 13 transmits the flight record information 530 to the management server 100.

### 5-3. Configuration Example of Management Server

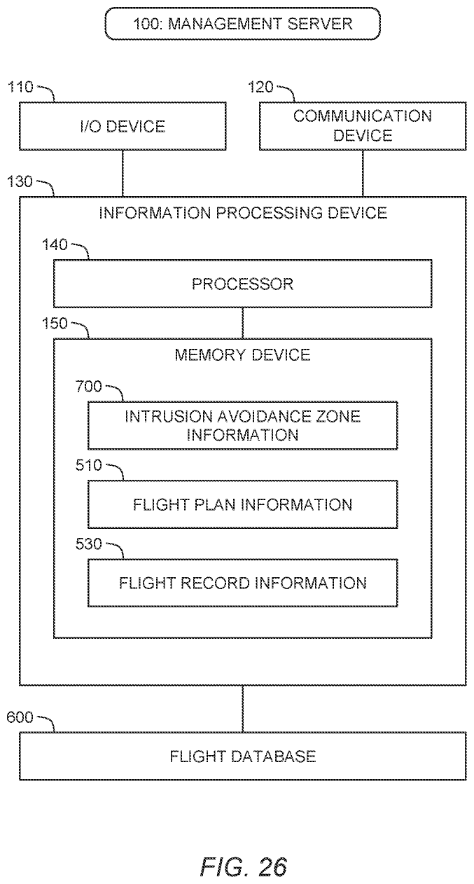

FIG. 26 is a block diagram showing a configuration example of the management server 100. An overlapping description with the above-described Section 2-6 and FIG. 9 will be omitted as appropriate. The management server 100 includes the input/output device 110, the communication device 120, and the information processing device 130.

Intrusion avoidance zone information 700, the flight plan information 510, and the flight record information 530 are stored in the memory device 150 of the information processing device 130.

The intrusion avoidance zone information 700 indicates the intrusion avoidance zone ZX into which the eVTOL 10 is recommended to refrain from intruding in terms of the safety criterion and the noise criterion. The intrusion avoidance zone ZX is set in advance based on three-dimensional terrain data. The intrusion avoidance zone ZX may be set two-dimensionally or may be set three-dimensionally. The intrusion avoidance zone information 700 is beforehand generated and stored in the memory device 150.

The flight plan information 510 includes the first point of departure DEP_F1, the first destination DST_F1, the target flight route RT1, and so forth regarding a new first flight F1. The flight plan information 510 is generated by a flight route determination process described later.

The flight record information 530 is acquired by each eVTOL 10, as described above. The information processing device 130 (i.e., the processor 140) receives the flight record information 530 from each eVTOL 10 through the communication device 120.

The information processing device 130 (i.e., the processor 140) is able to access a flight database 600. The flight database 600 is implemented by a predetermined memory device. The flight database 600 may be included in the memory device 150 of the management server 100. As another example, the flight database 600 may exist outside the management server 100. As described above, the flight database 600 includes the flight record information 530 regarding each past flight utilizing the eVTOL 10 (see FIGS. 22 to 24). The information processing device 130 registers the flight record information 530 received from each eVTOL 10 in the flight database 600. Moreover, the information processing device 130 is able to access the flight database 600 to read out necessary flight record information 530. The flight record information 530 read out from the flight database 600 is stored in the memory device 150.

Furthermore, the information processing device 130 (i.e., the processor 140) executes the flight route determination process. In the flight route determination process, the information processing device 130 determines the target flight route RT1 of the first flight F1 of the first eVTOL 10-1 from the first point of departure DEP_F1 to the first destination DST_F1. Typically, the information processing device 130 executes the flight route determination process in the itinerary planning process (Step S200) described in the above Section 3-2.

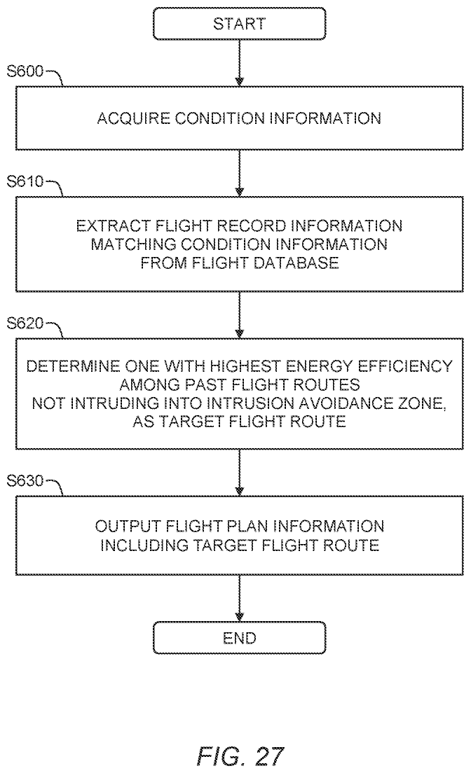

FIG. 27 is a flow chart showing the flight route determination process according to the present embodiment.

In Step S600, the information processing device 130 acquires the condition information. The condition information at least includes the combination of the first point of departure DEP_F1 and the first destination DST_F1 of the first flight F1. The condition information may include the model information of the first eVTOL 10-1. The condition information may include an expected weather condition at the time of the first flight F1. The expected weather condition at the time of the first flight F1 is obtained from general weather information.

In Step S610, the information processing device 130 accesses the flight database 600. Then, the information processing device 130 extracts the flight record information 530 matching the condition information acquired in Step S600, from the flight database 600. The condition information at least includes the combination of the first point of departure DEP_F1 and the first destination DST_F1 of the first flight F1. Therefore, the information processing device 130 extracts the flight record information 530 including at least the combination of the first point of departure DEP_F1 and the first destination DST_F1, from the flight database 600 (see FIG. 22).

The condition information registered in the flight database 600 exemplified in FIG. 23 includes the model information of the eVTOL 10 used in the past flight. The condition information acquired in Step S600 may further include the model information of the first eVTOL 10-1. In this case, the information processing device 130 extracts the flight record information 530 including not only the combination of the first point of departure DEP_F1 and the first destination DST_F1 but also the same model information as the first eVTOL 10-1, from the flight database 600.

The condition information registered in the flight database 600 exemplified in FIG. 24 includes the weather condition at the time of the past flight. The condition information acquired in Step S600 may further include an expected weather condition at the time of the first flight F1. In this case, the information processing device 130 extracts the flight record information 530 including not only the combination of the first point of departure DEP_F1 and the first destination DST_F1 but also the weather condition similar to the expected weather condition at the time of the first flight F1, from the flight database 600. Two weather conditions being similar to each other means that a degree of similarity of the two weather conditions is equal to or more than a threshold. The degree of similarity of the two weather conditions is calculated, for example, by a predetermined formula or a predetermined model that is based on differences in weather, wind speed, and wind direction.

In Step S620, the information processing device 130 accesses the intrusion avoidance zone information 700 to recognize the intrusion avoidance zone ZX. Then, the information processing device 130 determines the target flight route RT1 of the first flight F1 based on the flight record information 530 extracted in Step S610 and the intrusion avoidance zone information 700. More specifically, the information processing device 130 determines one with the highest energy efficiency among the past flight routes RT not intruding into the intrusion avoidance zone ZX, as the target flight route RT1 of the first flight F1.

For example, the information processing device 130 compares the flight route RT indicated by the flight record information 530 with the intrusion avoidance zone ZX to select the flight record information 530 indicating the flight route RT that does not intrude into the intrusion avoidance zone ZX. Further, the information processing device 130 makes a comparison between the energy efficiencies indicated by the selected flight record information 530. Then, the information processing device 130 finally selects single flight record information 530 indicating the highest energy efficiency. The flight route indicated by the single flight record information 530 selected is the target flight route RT1 of the first flight F1.

In this manner, the information processing device 130 determines one with the highest energy efficiency among past flight routes RT that are from the first point of departure DEP_F1 to the first destination DST_F1 and do not intrude into the intrusion avoidance zone ZX, as the target flight route RT1 of the first flight F1.

In Step S630, the information processing device 130 generates the flight plan information 510 regarding the first flight F1. The flight plan information 510 includes the first point of departure DEP_F1, the first destination DST_F1, and the target flight route RT1. The flight plan information 510 may include an expected flight time of the first flight F1. The expected flight time of the first flight F1 is the flight time indicated by the single flight record information 530 selected in Step S620. Then, the information processing device 130 communicates with the first eVTOL 10-1 through the communication device 120 to transmit the flight plan information 510 to the first eVTOL 10-1. In other words, the information processing device 130 notifies the first eVTOL 10-1 of the flight plan information 510 including the target flight route RT1.

The information processing device 13 of the first eVTOL 10-1 receives the flight plan information 510 from the management server 100. The information processing device 13 displays the flight plan information 510 on the display 11-1 of the input/output device 11. The pilot of the first eVTOL 10-1 operates the first eVTOL 10-1 while watching the flight plan information 510 displayed on the display 11-1. In particular, the pilot operates the first eVTOL 10-1 so as to fly along the target flight route RT1.

Moreover, the flight plan information 510 regarding the first flight F1 may be notified to the user of the first flight F1. The flight plan information 510 regarding the first flight F1 may be utilized for scheduling of the first eVTOL 10-1.

### 5-4. Modification Examples

A subject of the flight route determination process is not limited to the management server 100. The subject of the flight route determination process is arbitrary as long as it is able to access the flight database 600 and the intrusion avoidance zone information 700. For example, the first eVTOL 10-1 itself may access the flight database 600 and the intrusion avoidance zone information 700 to execute the flight route determination process. The flight route determination process may be executed by a plurality of devices in a distributed manner. To generalize, the flight route determination process is executed by one or more processors. Information necessary for the flight route determination process is stored in one or more memories.

As another example, the flight database 600 may be applied to forecast of balance of payment, pilot evaluation, and the like.

What is claimed is:

1. A mobility service system that delivers a mobility service utilizing an electric vertical takeoff and landing aircraft (hereinafter referred to as an eVTOL),
the mobility service system comprising:
one or more processors; and
one or more memories, wherein
the one or more memories are configured to store:
a flight database including flight record information at least indicating a correspondence relationship between a combination of a point of departure and a destination, a flight route, and an energy efficiency, regarding each past flight utilizing the eVTOL; and
intrusion avoidance zone information indicating an intrusion avoidance zone into which the eVTOL is recommended to refrain from intruding,
the one or more processors are configured to execute a flight route determination process that determines a target flight route of a first flight of a first eVTOL from a first point of departure to a first destination, and
in the flight route determination process, based on the flight database and the intrusion avoidance zone information, the one or more processors determine one with a highest energy efficiency among past flight routes that are from the first point of departure to the first destination and do not intrude into the intrusion avoidance zone, as the target flight route of the first flight.

2. The mobility service system according to claim 1, wherein
the flight record information further indicates model information of the eVTOL used in the past flight, and
in the flight route determination process, the one or more processors determine the target flight route of the first flight based on the flight record information related to a same model as the first eVTOL.

3. The mobility service system according to claim 1, wherein
the flight record information further indicates a weather condition at a time of the past flight, and
in the flight route determination process, the one or more processors determine the target flight route of the first flight based on the flight record information related to the weather condition whose degree of similarity with an expected weather condition at a time of the first flight is equal to or more than a threshold.

4. The mobility service system according to claim 1, wherein
the one or more processors are further configured to notify the first eVTOL of the target flight route of the first flight.

5. The mobility service system according to claim 1, wherein
the intrusion avoidance zone is a zone that does not meet at least one of a safety criterion and a noise criterion.

6. A mobility service delivery method that delivers a mobility service utilizing an electric vertical takeoff and landing aircraft (hereinafter referred to as an eVTOL), wherein the mobility service delivery method is performed by a computer executing a computer program,
the mobility service delivery method comprising a flight route determination process that determines a target flight route of a first flight of a first eVTOL from a first point of departure to a first destination, wherein
the flight route determination process includes:
accessing a flight database including flight record information at least indicating a correspondence relationship between a combination of a point of departure and a destination, a flight route, and an energy efficiency, regarding each past flight utilizing the eVTOL;
accessing intrusion avoidance zone information indicating an intrusion avoidance zone into which the eVTOL is recommended to refrain from intruding; and
determining, based on the flight database and the intrusion avoidance zone information, one with a highest energy efficiency among past flight routes that are from the first point of departure to the first destination and do not intrude into the intrusion avoidance zone, as the target flight route of the first flight.
